(19) United States
(12) Patent Application Publication
(10) Pub. No.: US 2026/0186797 A1
(43) Pub. Date: Jul. 2, 2026

(54) SECURELY CUSTOMIZING USER INTERFACES IN SOFTWARE CONTROLLED ACROSS MULTIPLE DEVICES

(71) Applicant: Truist Bank, Charlotte, NC (US)

(72) Inventors: Ganesh Kumar Thandavarayan, Apex, NC (US); Raghavendra P. Narasimhan, Cary, NC (US)

(73) Assignee: Truist Bank, Charlotte, NC (US)

(21) Appl. No.: 19/007,611

(22) Filed: Jan. 2, 2025

(51) Int. Cl. G06F 9/451; G06F 9/48; G06F 21/44

(52) U.S. Cl. CPC G06F 9/451; G06F 9/48; G06F 21/44

(57) ABSTRACT

To securely customize user interfaces in software controlled across multiple devices, a computing system reads a user-specific profile associated with received login credentials and a specific user, the profile containing an application list, and conducts a user session that includes opening a listed application thereby causing via the network connection a user device to display items in a user interface in a display arrangement specified in a configuration file in the user-specific profile. The user device sends user commands to modify the display arrangement. The computing system modifies the configuration file, and upon a subsequent opening of the particular application for the specific user, items are displayed in a display arrangement specified in the modified configuration file.

### TECHNICAL FIELD

The present disclosure relates to tools for customizing user interfaces by end users. More particularly, the present disclosure relates to customizing user interfaces by end users, and automatic recovery of user settings upon next use.

### BACKGROUND

Commercial entities and consumers as well need flexibility in how they manage their online activities. Remote work is increasingly popular. Workers in many professions are using software applications to conduct work online and access services and resources for their employers and for their personal use.

Users crave personalized experiences when engaging with applications. They anticipate high levels of customizations that cater to their unique preferences and requirements. Workers and consumers alike tend to customize user interfaces, and can typically accomplish tasks most efficiently using their own preferred and familiar display arrangements. Time can be lost by workers and consumers reconfiguring user interfaces each time applications and other programs are initiated. Remote workers, office workers, and consumers are focusing in smaller time parcels as communications diversify from now almost obsolete once-daily paper mail deliveries to incoming messages such as email and text messages pouring in during all hours. Small efficiencies that could be gained by workers using familiar interface arrangements and those arrangements being easily regained upon re-opening user interfaces would be of higher value than ever before.

Improvements are needed in customizing user interfaces in software used across multiple devices.

### SUMMARY

This summary is provided to briefly introduce concepts that are further described in the following detailed descriptions. This summary is not intended to identify key features or essential features of the claimed subject matter, nor is it to be construed as limiting the scope of the claimed subject matter.

According to at least one embodiment, a system for securely customizing user interfaces in software controlled across multiple devices is provided. The system includes a computing system having one or more processor and at least one of a memory device and a non-transitory storage device. The one or more processor executes computer-readable instructions. A network connection operatively connects multiple user devices to the computing system. Upon execution of the computer-readable instructions, the computing system performs steps comprising, for each user device of the multiple user devices: receiving, via the network connection, login credentials from a specific user device of the multiple user devices; reading a user-specific profile associated with the received login credentials and a specific user, the user-specific profile containing at least an application list identifying at least one particular application available to the specific user; and initiating and conducting a current user session via the specific user device. The current user session includes the computing system: opening the particular application thereby causing via the network connection displaying by the specific user device items in a display arrangement in a user interface, the display arrangement specified in a configuration file in the user-specific profile; receiving user commands from the specific user device, the user commands comprising instructions to modify the display arrangement; modifying the configuration file according at least to the instructions to modify the display arrangement; storing the modified configuration file in the user specific profile; and upon a subsequent opening of the particular application for the specific user, causing displaying, by the specific user device or other device used by the specific user upon the subsequent opening, items in a display arrangement specified in the modified configuration file.

The instructions to modify the display arrangement may include at least one of instructions to resize a window, instructions to reposition a window, instructions to select a background image in a window, and instructions to adjust a background image in a window.

The instructions to modify the display arrangement may include at least one of instructions to set a property on a form, instructions to set or revise whether a form should automatically prepopulate one or more field, instructions to set or revise whether a form should automatically perform a query, instructions to set or revise whether a form should open a query dialog, instructions to set or revise whether a form should create a new record, and instructions to set or revise whether at least one field in a form should start empty when initiated.

The user-specific profile may include a start-up list identifying each of one or more application for automatic opening upon initiating a user session.

Reading the user-specific profile associated with the received login credentials may include reading each identification in the start-up list.

Opening the particular application may be done automatically upon: reading the user-specific profile comprising reading an identification of the particular application in the start-up list; and initiating the current user session.

In some examples, the computing system further: receives a user command from the specific user device to include an identification of a specific application in the start-up list; automatically determines whether the specific application is identified in the application list in the user-specific profile; and upon determining the specific application is identified in the application list in the user-specific profile, adds the identification of the specific application in the start-up list.

In many uses, upon initiating and conducting the current user session via the specific user device, the computing system concurrently conducts multiple other user sessions via other respective user devices.

In at least some embodiments, for which the above options and examples apply as well, a system for securely customizing user interfaces in software controlled across multiple devices is provided. The system includes: a computing system having one or more processor and at least one of a memory device and a non-transitory storage device, wherein said at least one of a memory device and a non-transitory storage device include stored computer-readable instructions and multiple user-specific profiles, each user-specific profile having an application list identifying applications available to a respective specific user, and a start-up list identifying which of the available applications are to be automatically opened upon initiating a user session for the specific user. The one or more processor executes the computer-readable instructions. A network connection operatively connects multiple user devices to the computing system. Upon the one or more processor executing the computer-readable instructions, the computing system performs steps including, for each user device of the multiple user devices: receiving, via the network connection, login credentials from a particular user device of the multiple user devices; reading a particular user-specific profile of the multiple user-specific profiles, the particular user-specific profile associated with the received login credentials and a particular user; and initiating and conducting a current user session for the particular user via the particular user device. The current user session includes the computing system: automatically opening each of the available applications identified in the start-up list in the particular user-specific profile, thereby causing via the network connection displaying by the particular user device, items in a display arrangement in a user interface, the display arrangement specified in a configuration file in the particular user-specific profile; receiving user commands from the specific user device, the user commands including instructions to modify the display arrangement; modifying the configuration file according at least to the instructions to modify the display arrangement; storing the modified configuration file in the particular user specific profile; and upon a subsequent opening of the particular application for the particular user, causing displaying, by the particular user device or other user device used by the particular user upon the subsequent opening, items in a display arrangement specified in the modified configuration file.

In some embodiments, for which the above-described options and examples apply as well, a computer-implemented method is provided for a computing system to securely customize user interfaces in software controlled across multiple devices. The computing system includes one or more processor and at least one of a memory device and a non-transitory storage device storing computer-readable instructions, the one or more processor configured to execute the computer-readable instructions, and a network connection for operatively connecting multiple user devices to the computing system. The method includes, upon execution of the computer-readable instructions, the computing system performing steps including, concurrently for each user device of the multiple user devices: receiving, via the network connection, login credentials from a specific user device of the multiple user devices; reading a user-specific profile associated with the received login credentials and a specific user, the user-specific profile containing at least an application list identifying at least one particular application available to the specific user; and initiating and conducting a current user session via the specific user device. The current user session includes the computing system: opening the particular application thereby causing via the network connection displaying by the specific user device, items in a display arrangement in a user interface, the display arrangement specified in a configuration file in the user-specific profile; receiving user commands from the specific user device, the user commands comprising instructions to modify the display arrangement; modifying the configuration file according at least to the instructions to modify the display arrangement; storing the modified configuration file in the user specific profile; and upon a subsequent opening of the particular application for the specific user, causing displaying, by the specific user device or other device used by the specific user upon the subsequent opening, items in a display arrangement specified in the modified configuration file.

The above summary is to be understood as cumulative and inclusive. The above and below described features are to be understood as combined in whole or in part in various embodiments whether expressly described herein or implied by at least this reference. For brevity, not all features are expressly described and illustrated as combined with all other features. No combination of features shall be deemed unsupported for merely not appearing expressly in the drawings and descriptions.

### BRIEF DESCRIPTION OF THE DRAWINGS

The previous summary and the following detailed descriptions are to be read in view of the drawings, which illustrate some, but not all, embodiments and features as briefly described below. The summary and detailed descriptions, however, are not limited to only those embodiments and features explicitly illustrated.

FIG. 1 illustrates an enterprise system and environment thereof, in accordance with various embodiments of the present invention.

FIG. 2 represents the system of FIG. 1 in abbreviated illustration to exemplify a system for securely customizing user interfaces in software controlled across multiple devices.

FIG. 3 is a flow chart representing a method for securely customizing user interfaces in software controlled across multiple devices as implemented for example in FIG. 2.

### DETAILED DESCRIPTIONS

These descriptions are presented with sufficient details to provide an understanding of one or more particular embodiments of broader inventive subject matters. These descriptions expound upon and exemplify particular features of those particular embodiments without limiting the inventive subject matters to the explicitly described embodiments and features. Considerations in view of these descriptions will likely give rise to additional and similar embodiments and features without departing from the scope of the inventive subject matters. Although steps may be expressly described or implied relating to features of processes or methods, no implication is made of any particular order or sequence among such expressed or implied steps unless an order or sequence is explicitly stated.

Any dimensions expressed or implied in the drawings and these descriptions are provided for exemplary purposes. Thus, not all embodiments within the scope of the drawings and these descriptions are made according to such exemplary dimensions. The drawings are not made necessarily to scale. Thus, not all embodiments within the scope of the drawings and these descriptions are made according to the apparent scale of the drawings with regard to relative dimensions in the drawings. However, for each drawing, at least one embodiment is made according to the apparent relative scale of the drawing.

Embodiments of the present invention will now be described more fully hereinafter with reference to the accompanying drawings, in which some, but not all, embodiments of the invention are shown. Indeed, the invention may be embodied in many different forms and should not be construed as limited to the embodiments set forth herein. Like numbers refer to like elements throughout. Unless described or implied as exclusive alternatives, features throughout the drawings and descriptions should be taken as cumulative, such that features expressly associated with some particular embodiments can be combined with other embodiments. Unless defined otherwise, technical and scientific terms used herein have the same meaning as commonly understood to one of ordinary skill in the art to which the presently disclosed subject matter pertains.

The exemplary embodiments are provided so that this disclosure will be both thorough and complete, and will fully convey the scope of the invention and enable one of ordinary skill in the art to make, use, and practice the invention.

The terms “coupled,” “fixed,” “attached to,” “communicatively coupled to,” “operatively coupled to,” and the like refer to both (i) direct connecting, coupling, fixing, attaching, communicatively coupling; and (ii) indirect connecting coupling, fixing, attaching, communicatively coupling via one or more intermediate components or features, unless otherwise specified herein. “Communicatively coupled to” and “operatively coupled to” can refer to physically and/or electrically related components.

Embodiments of the present invention described herein, with reference to illustrations and/or block diagrams of systems and apparatuses (the term “apparatus” includes systems and computer program products), will be understood such that each function described or implied with reference to the illustrations and/or block diagrams, can be implemented by computer program instructions. These computer program instructions may be provided to a processor of a general purpose computer, special purpose computer, or other programmable data processing apparatus to produce a particular machine, such that the instructions, which execute via the processor of the computer or other programmable data processing apparatus, create mechanisms for implementing the functions/acts described, illustrated, and/or implied.

These computer program instructions may also be stored in a computer-readable memory that can direct a computer or other programmable data processing apparatus to function in a particular manner, such that the instructions stored in the computer readable memory produce an article of manufacture including instructions, which implement the function/act described, illustrated, and/or implied.

The computer program instructions may also be loaded onto a computer or other programmable data processing apparatus to cause a series of operational steps to be performed on the computer or other programmable apparatus to produce a computer implemented process such that the instructions, which execute on the computer or other programmable apparatus, provide steps for implementing the functions/acts described, illustrated, and/or implied. Alternatively, computer program implemented steps or acts may be combined with operator or human implemented steps or acts in order to carry out an embodiment of the invention.

While certain exemplary embodiments have been described and shown in the accompanying drawings, it is to be understood that such embodiments are merely illustrative of, and not restrictive on, the broad invention, and that this invention not be limited to the specific constructions and arrangements shown and described, since various other changes, combinations, omissions, modifications and substitutions, in addition to those set forth in the above paragraphs, are possible. Those skilled in the art will appreciate that various adaptations, modifications, and combinations of the herein described embodiments can be configured without departing from the scope and spirit of the invention. Therefore, it is to be understood that, within the scope of the included claims, the invention may be practiced other than as specifically described herein. Where functions of hardware and software are described herein, related methods are detailed therewith, such that methods are disclosed as well.

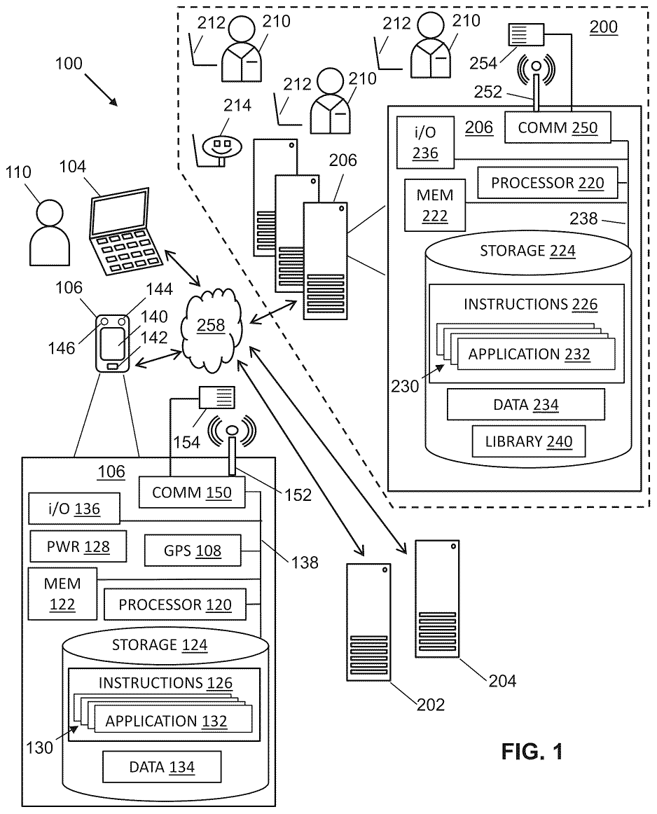

FIG. 1 illustrates a system 100 and environment thereof, according to at least one embodiment, by which a user 110 benefits through use of services and products of, or those provided at least in part with use of, an enterprise system 200. The environment may include, for example, a distributed cloud computing environment (private cloud, public cloud, community cloud, and/or hybrid cloud), an on-premise environment, fog computing environment, and/or an edge computing environment. The user 110 accesses services and products by use of one or more user devices, illustrated in separate examples as a computing device 104 and a mobile device 106, which may be, as non-limiting examples, a smart phone, a portable digital assistant (PDA), a pager, a mobile television, a gaming device, a laptop computer, a camera, a video recorder, an audio/video player, radio, a GPS device, or any combination of the aforementioned, or other portable device with processing and communication capabilities. In the illustrated example, the mobile device 106 is illustrated in FIG. 1 as having exemplary elements, the below descriptions of which apply as well to the computing device 104, which can be, as non-limiting examples, a desktop computer, a laptop computer, or other user-accessible computing device.

Furthermore, the user device, referring to either or both of the computing device 104 and the mobile device 106, may be or include a workstation, a server, or any other suitable device, including a set of servers, a cloud-based application or system, or any other suitable system, adapted to execute, for example any suitable operating system, including Linux, UNIX, Windows, macOS, iOS, Android and any other known operating system used on personal computers, central computing systems, phones, and other devices.

The user 110 can be an individual, a group, or any entity in possession of or having access to the user device, referring to either or both of the mobile device 104 and computing device 106, which may be personal or public items. Although the user 110 may be singly represented in some drawings, at least in some embodiments according to these descriptions the user 110 is one of many such that a market or community of users, consumers, customers, business entities, government entities, clubs, and groups of any size are all within the scope of these descriptions.

The user device, as illustrated with reference to the mobile device 106, includes components such as, at least one of each of a processing device 120, and a memory device 122 for processing use, such as random access memory (RAM), and read-only memory (ROM). The illustrated mobile device 106 further includes a storage device 124 including at least one of a non-transitory storage medium, such as a microdrive, for long-term, intermediate-term, and short-term storage of computer-readable instructions 126 for execution by the processing device 120. For example, the instructions 126 can include instructions for an operating system and various applications or programs 130, of which the application 132 is represented as a particular example. The storage device 124 can store various other data items 134, which can include, as non-limiting examples, cached data, user files such as those for pictures, audio and/or video recordings, files downloaded or received from other devices, and other data items preferred by the user or required or related to any or all of the applications or programs 130.

The memory device 122 is operatively coupled to the processing device 120. As used herein, memory includes any computer readable medium to store data, code, or other information. The memory device 122 may include volatile memory, such as volatile Random Access Memory (RAM) including a cache area for the temporary storage of data. The memory device 122 may also include non-volatile memory, which can be embedded and/or may be removable. The non-volatile memory can additionally or alternatively include an electrically erasable programmable read-only memory (EEPROM), flash memory or the like.

According to various embodiments, the memory device 122 and storage device 124 may be combined into a single storage medium. The memory device 122 and storage device 124 can store any of a number of applications which comprise computer-executable instructions and code executed by the processing device 120 to implement the functions of the mobile device 106 described herein. For example, the memory device 122 may include such applications as a conventional web browser application and/or a mobile P2P payment system client application. These applications also typically provide a graphical user interface (GUI) on the display 140 that allows the user 110 to communicate with the mobile device 106, and, for example a mobile banking system, and/or other devices or systems. In one embodiment, when the user 110 decides to enroll in a mobile banking program, the user 110 downloads or otherwise obtains the mobile banking system client application from a mobile banking system, for example enterprise system 200, or from a distinct application server. In other embodiments, the user 110 interacts with a mobile banking system via a web browser application in addition to, or instead of, the mobile P2P payment system client application.

The processing device 120, and other processors described herein, generally include circuitry for implementing communication and/or logic functions of the mobile device 106. For example, the processing device 120 may include a digital signal processor, a microprocessor, and various analog to digital converters, digital to analog converters, and/or other support circuits. Control and signal processing functions of the mobile device 106 are allocated between these devices according to their respective capabilities. The processing device 120 thus may also include the functionality to encode and interleave messages and data prior to modulation and transmission. The processing device 120 can additionally include an internal data modem. Further, the processing device 120 may include functionality to operate one or more software programs, which may be stored in the memory device 122, or in the storage device 124. For example, the processing device 120 may be capable of operating a connectivity program, such as a web browser application. The web browser application may then allow the mobile device 106 to transmit and receive web content, such as, for example, location-based content and/or other web page content, according to a Wireless Application Protocol (WAP), Hypertext Transfer Protocol (HTTP), and/or the like.

The memory device 122 and storage device 124 can each also store any of a number of pieces of information, and data, used by the user device and the applications and devices that facilitate functions of the user device, or are in communication with the user device, to implement the functions described herein and others not expressly described. For example, the storage device may include such data as user authentication information, etc.

The processing device 120, in various examples, can operatively perform calculations, can process instructions for execution, and can manipulate information. The processing device 120 can execute machine-executable instructions stored in the storage device 124 and/or memory device 122 to thereby perform methods and functions as described or implied herein, for example by one or more corresponding flow charts expressly provided or implied as would be understood by one of ordinary skill in the art to which the subject matters of these descriptions pertain. The processing device 120 can be or can include, as non-limiting examples, a central processing unit (CPU), a microprocessor, a graphics processing unit (GPU), a microcontroller, an application-specific integrated circuit (ASIC), a programmable logic device (PLD), a digital signal processor (DSP), a field programmable gate array (FPGA), a state machine, a controller, gated or transistor logic, discrete physical hardware components, and combinations thereof. In some embodiments, particular portions or steps of methods and functions described herein are performed in whole or in part by way of the processing device 120, while in other embodiments methods and functions described herein include cloud-based computing in whole or in part such that the processing device 120 facilitates local operations including, as non-limiting examples, communication, data transfer, and user inputs and outputs such as receiving commands from and providing displays to the user.

The mobile device 106, as illustrated, includes an input and output system 136, referring to, including, or operatively coupled with, one or more user input devices and/or one or more user output devices, which are operatively coupled to the processing device 120. The input and output system 136 may include input/output circuitry that may operatively convert analog signals and other signals into digital data, or may convert digital data to another type of signal. For example, the input/output circuitry may receive and convert physical contact inputs, physical movements, or auditory signals (e.g., which may be used to authenticate a user) to digital data. Once converted, the digital data may be provided to the processing device 120. The input and output system 136 may also include a display 140 (e.g., a liquid crystal display (LCD), light emitting diode (LED) display, or the like), which can be, as a non-limiting example, a presence-sensitive input screen (e.g., touch screen or the like) of the mobile device 106, which serves both as an output device, by providing graphical and text indicia and presentations for viewing by one or more user 110, and as an input device, by providing virtual buttons, selectable options, a virtual keyboard, and other indicia that, when touched, control the mobile device 106 by user action. The user output devices include a speaker 144 or other audio device. The user input devices, which allow the mobile device 106 to receive data and actions such as button manipulations and touches from a user such as the user 110, may include any of a number of devices allowing the mobile device 106 to receive data from a user, such as a keypad, keyboard, touch-screen, touchpad, microphone 142, mouse, joystick, other pointer device, button, soft key, infrared sensor, and/or other input device(s). The input and output system 136 may also include a camera 146, such as a digital camera.

Further non-limiting examples of input devices and/or output devices include, one or more of each, any, and all of a wireless or wired keyboard, a mouse, a touchpad, a button, a switch, a light, an LED, a buzzer, a bell, a printer and/or other user input devices and output devices for use by or communication with the user 110 in accessing, using, and controlling, in whole or in part, the user device, referring to either or both of the computing device 104 and a mobile device 106. Inputs by one or more user 110 can thus be made via voice, text or graphical indicia selections. For example, such inputs in some examples correspond to user-side actions and communications seeking services and products of the enterprise system 200, and at least some outputs in such examples correspond to data representing enterprise-side actions and communications in two-way communications between a user 110 and an enterprise system 200.

The input and output system 136 may also be configured to obtain and process various forms of authentication via an authentication system to obtain authentication information of a user 110. Various authentication systems may include, according to various embodiments, a recognition system that detects biometric features or attributes of a user such as, for example fingerprint recognition systems and the like (hand print recognition systems, palm print recognition systems, etc.), iris recognition and the like used to authenticate a user based on features of the user's eyes, facial recognition systems based on facial features of the user, DNA-based authentication, or any other suitable biometric attribute or information associated with a user. Additionally or alternatively, voice biometric systems may be used to authenticate a user using speech recognition associated with a word, phrase, tone, or other voice-related features of the user. Alternate authentication systems may include one or more systems to identify a user based on a visual or temporal pattern of inputs provided by the user. For instance, the user device may display, for example, selectable options, shapes, inputs, buttons, numeric representations, etc. that must be selected in a pre-determined specified order or according to a specific pattern. Other authentication processes are also contemplated herein including, for example, email authentication, password protected authentication, device verification of saved devices, code-generated authentication, text message authentication, phone call authentication, etc. The user device may enable users to input any number or combination of authentication systems.

The user device, referring to either or both of the computing device 104 and the mobile device 106 may also include a positioning device 108, which can be for example a global positioning system device (GPS) configured to be used by a positioning system to determine a location of the computing device 104 or mobile device 106. For example, the positioning system device 108 may include a GPS transceiver. In some embodiments, the positioning system device 108 includes an antenna, transmitter, and receiver. For example, in one embodiment, triangulation of cellular signals may be used to identify the approximate location of the mobile device 106. In other embodiments, the positioning device 108 includes a proximity sensor or transmitter, such as an RFID tag, that can sense or be sensed by devices known to be located proximate a merchant or other location to determine that the consumer mobile device 106 is located proximate these known devices.

In the illustrated example, a system intraconnect 138, connects, for example electrically, the various described, illustrated, and implied components of the mobile device 106. The intraconnect 138, in various non-limiting examples, can include or represent, a system bus, a high-speed interface connecting the processing device 120 to the memory device 122, individual electrical connections among the components, and electrical conductive traces on a motherboard common to some or all of the above-described components of the user device (referring to either or both of the computing device 104 and the mobile device 106). As discussed herein, the system intraconnect 138 may operatively couple various components with one another, or in other words, electrically connects those components, either directly or indirectly—by way of intermediate component(s)—with one another.

The user device, referring to either or both of the computing device 104 and the mobile device 106, with particular reference to the mobile device 106 for illustration purposes, includes a communication interface 150, by which the mobile device 106 communicates and conducts transactions with other devices and systems. The communication interface 150 may include digital signal processing circuitry and may provide two-way communications and data exchanges, for example wirelessly via wireless communication device 152, and for an additional or alternative example, via wired or docked communication by mechanical electrically conductive connector 154. Communications may be conducted via various modes or protocols, of which GSM voice calls, SMS, EMS, MMS messaging, TDMA, CDMA, PDC, WCDMA, CDMA2000, and GPRS, are all non-limiting and non-exclusive examples. Thus, communications can be conducted, for example, via the wireless communication device 152, which can be or include a radio-frequency transceiver, a Bluetooth device, Wi-Fi device, a Near-field communication device, and other transceivers. In addition, GPS (Global Positioning System) may be included for navigation and location-related data exchanges, ingoing and/or outgoing. Communications may also or alternatively be conducted via the connector 154 for wired connections such by USB, Ethernet, and other physically connected modes of data transfer.

The processing device 120 is configured to use the communication interface 150 as, for example, a network interface to communicate with one or more other devices on a network. In this regard, the communication interface 150 utilizes the wireless communication device 152 as an antenna operatively coupled to a transmitter and a receiver (together a “transceiver”) included with the communication interface 150. The processing device 120 is configured to provide signals to and receive signals from the transmitter and receiver, respectively. The signals may include signaling information in accordance with the air interface standard of the applicable cellular system of a wireless telephone network. In this regard, the mobile device 106 may be configured to operate with one or more air interface standards, communication protocols, modulation types, and access types. By way of illustration, the mobile device 106 may be configured to operate in accordance with any of a number of first, second, third, fourth, fifth-generation communication protocols and/or the like. For example, the mobile device 106 may be configured to operate in accordance with second-generation (2G) wireless communication protocols IS-136 (time division multiple access (TDMA)), GSM (global system for mobile communication), and/or IS-95 (code division multiple access (CDMA)), or with third-generation (3G) wireless communication protocols, such as Universal Mobile Telecommunications System (UMTS), CDMA2000, wideband CDMA (WCDMA) and/or time division-synchronous CDMA (TD-SCDMA), with fourth-generation (4G) wireless communication protocols such as Long-Term Evolution (LTE), fifth-generation (5G) wireless communication protocols, Bluetooth Low Energy (BLE) communication protocols such as Bluetooth 5.0, ultra-wideband (UWB) communication protocols, and/or the like. The mobile device 106 may also be configured to operate in accordance with non-cellular communication mechanisms, such as via a wireless local area network (WLAN) or other communication/data networks.

The communication interface 150 may also include a payment network interface. The payment network interface may include software, such as encryption software, and hardware, such as a modem, for communicating information to and/or from one or more devices on a network. For example, the mobile device 106 may be configured so that it can be used as a credit or debit card by, for example, wirelessly communicating account numbers or other authentication information to a terminal of the network. Such communication could be performed via transmission over a wireless communication protocol such as the Near-field communication protocol.

The mobile device 106 further includes a power source 128, such as a battery, for powering various circuits and other devices that are used to operate the mobile device 106. Embodiments of the mobile device 106 may also include a clock or other timer configured to determine and, in some cases, communicate actual or relative time to the processing device 120 or one or more other devices. For further example, the clock may facilitate timestamping transmissions, receptions, and other data for security, authentication, logging, polling, data expiry, and forensic purposes.

System 100 as illustrated diagrammatically represents at least one example of a possible implementation, where alternatives, additions, and modifications are possible for performing some or all of the described methods, operations and functions. Although shown separately, in some embodiments, two or more systems, servers, or illustrated components may utilized. In some implementations, the functions of one or more systems, servers, or illustrated components may be provided by a single system or server. In some embodiments, the functions of one illustrated system or server may be provided by multiple systems, servers, or computing devices, including those physically located at a central facility, those logically local, and those located as remote with respect to each other.

The enterprise system 200 can offer any number or type of services and products to one or more users 110. In some examples, an enterprise system 200 offers products. In some examples, an enterprise system 200 offers services. Use of “service(s)” or “product(s)” thus relates to either or both in these descriptions. With regard, for example, to online information and financial services, “service” and “product” are sometimes termed interchangeably. In non-limiting examples, services and products include retail services and products, information services and products, custom services and products, predefined or pre-offered services and products, consulting services and products, advising services and products, forecasting services and products, internet products and services, social media, and financial services and products, which may include, in non-limiting examples, services and products relating to banking, checking, savings, investments, credit cards, automatic-teller machines, debit cards, loans, mortgages, personal accounts, business accounts, account management, credit reporting, credit requests, and credit scores.

To provide access to, or information regarding, some or all the services and products of the enterprise system 200, automated assistance may be provided by the enterprise system 200. For example, automated access to user accounts and replies to inquiries may be provided by enterprise-side automated voice, text, and graphical display communications and interactions. In at least some examples, any number of human agents 210, can be employed, utilized, authorized or referred by the enterprise system 200. Such human agents 210 can be, as non-limiting examples, point of sale or point of service (POS) representatives, online customer service assistants available to users 110, advisors, managers, sales team members, and referral agents ready to route user requests and communications to preferred or particular other agents, human or virtual.

Human agents 210 may utilize agent devices 212 to serve users in their interactions to communicate and take action. The agent devices 212 can be, as non-limiting examples, computing devices, kiosks, terminals, smart devices such as phones, and devices and tools at customer service counters and windows at POS locations. In at least one example, the diagrammatic representation of the components of the user device 106 in FIG. 1 applies as well to one or both of the computing device 104 and the agent devices 212.

Agent devices 212 individually or collectively include input devices and output devices, including, as non-limiting examples, a touch screen, which serves both as an output device by providing graphical and text indicia and presentations for viewing by one or more agent 210, and as an input device by providing virtual buttons, selectable options, a virtual keyboard, and other indicia that, when touched or activated, control or prompt the agent device 212 by action of the attendant agent 210. Further non-limiting examples include, one or more of each, any, and all of a keyboard, a mouse, a touchpad, a joystick, a button, a switch, a light, an LED, a microphone serving as input device for example for voice input by a human agent 210, a speaker serving as an output device, a camera serving as an input device, a buzzer, a bell, a printer and/or other user input devices and output devices for use by or communication with a human agent 210 in accessing, using, and controlling, in whole or in part, the agent device 212.

Inputs by one or more human agents 210 can thus be made via voice, text or graphical indicia selections. For example, some inputs received by an agent device 212 in some examples correspond to, control, or prompt enterprise-side actions and communications offering services and products of the enterprise system 200, information thereof, or access thereto. At least some outputs by an agent device 212 in some examples correspond to, or are prompted by, user-side actions and communications in two-way communications between a user 110 and an enterprise-side human agent 210.

From a user perspective experience, an interaction in some examples within the scope of these descriptions begins with direct or first access to one or more human agents 210 in person, by phone, or online for example via a chat session or website function or feature. In other examples, a user is first assisted by a virtual agent 214 of the enterprise system 200, which may satisfy user requests or prompts by voice, text, or online functions, and may refer users to one or more human agents 210 once preliminary determinations or conditions are made or met.

A computing system 206 of the enterprise system 200 may include components such as, at least one of each of a processing device 220, and a memory device 222 for processing use, such as random access memory (RAM), and read-only memory (ROM). The illustrated computing system 206 further includes a storage device 224 including at least one non-transitory storage medium, such as a microdrive, for long-term, intermediate-term, and short-term storage of computer-readable instructions 226 for execution by the processing device 220. For example, the instructions 226 can include instructions for an operating system and various applications or programs 230, of which the application 232 is represented as a particular example. The storage device 224 can store various other data 234, which can include, as non-limiting examples, cached data, and files such as those for user accounts, user profiles, account balances, and transaction histories, files downloaded or received from other devices, and other data items preferred by the user or required or related to any or all of the applications or programs 230.

The computing system 206, in the illustrated example, includes an input/output system 236, referring to, including, or operatively coupled with input devices and output devices such as, in a non-limiting example, agent devices 212, which have both input and output capabilities.

In the illustrated example, a system intraconnect 238 electrically connects the various above-described components of the computing system 206. In some cases, the intraconnect 238 operatively couples components to one another, which indicates that the components may be directly or indirectly connected, such as by way of one or more intermediate components. The intraconnect 238, in various non-limiting examples, can include or represent, a system bus, a high-speed interface connecting the processing device 220 to the memory device 222, individual electrical connections among the components, and electrical conductive traces on a motherboard common to some or all of the above-described components of the user device.

The computing system 206, in the illustrated example, includes a communication interface 250, by which the computing system 206 communicates and conducts transactions with other devices and systems. The communication interface 250 may include digital signal processing circuitry and may provide two-way communications and data exchanges, for example wirelessly via wireless device 252, and for an additional or alternative example, via wired or docked communication by mechanical electrically conductive connector 254. Communications may be conducted via various modes or protocols, of which GSM voice calls, SMS, EMS, MMS messaging, TDMA, CDMA, PDC, WCDMA, CDMA2000, and GPRS, are all non-limiting and non-exclusive examples. Thus, communications can be conducted, for example, via the wireless device 252, which can be or include a radio-frequency transceiver, a Bluetooth device, Wi-Fi device, Near-field communication device, and other transceivers. In addition, GPS (Global Positioning System) may be included for navigation and location-related data exchanges, ingoing and/or outgoing. Communications may also or alternatively be conducted via the connector 254 for wired connections such as by USB, Ethernet, and other physically connected modes of data transfer.

The processing device 220, in various examples, can operatively perform calculations, can process instructions for execution, and can manipulate information. The processing device 220 can execute machine-executable instructions stored in the storage device 224 and/or memory device 222 to thereby perform methods and functions as described or implied herein, for example by one or more corresponding flow charts expressly provided or implied as would be understood by one of ordinary skill in the art to which the subjects matters of these descriptions pertain. The processing device 220 can be or can include, as non-limiting examples, a central processing unit (CPU), a microprocessor, a graphics processing unit (GPU), a microcontroller, an application-specific integrated circuit (ASIC), a programmable logic device (PLD), a digital signal processor (DSP), a field programmable gate array (FPGA), a state machine, a controller, gated or transistor logic, discrete physical hardware components, and combinations thereof.

Furthermore, the computing device 206, may be or include a workstation, a server, or any other suitable device, including a set of servers, a cloud-based application or system, or any other suitable system, adapted to execute, for example any suitable operating system, including Linux, UNIX, Windows, macOS, iOS, Android, and any known other operating system used on personal computer, central computing systems, phones, and other devices.

The user devices, referring to either or both of the computing device 104 and mobile device 106, the agent devices 212, and the enterprise computing system 206, which may be one or any number centrally located or distributed, are in communication through one or more networks, referenced as network 258 in FIG. 1.

Network 258 provides wireless or wired communications among the components of the system 100 and the environment thereof, including other devices local or remote to those illustrated, such as additional mobile devices, servers, and other devices communicatively coupled to network 258, including those not illustrated in FIG. 1. The network 258 is singly depicted for illustrative convenience, but may include more than one network without departing from the scope of these descriptions. In some embodiments, the network 258 may be or provide one or more cloud-based services or operations. The network 258 may be or include an enterprise or secured network, or may be implemented, at least in part, through one or more connections to the Internet. A portion of the network 258 may be a virtual private network (VPN) or an Intranet. The network 258 can include wired and wireless links, including, as non-limiting examples, 802.11a/b/g/n/ac, 802.20, WiMax, LTE, and/or any other wireless link. The network 258 may include any internal or external network, networks, sub-network, and combinations of such operable to implement communications between various computing components within and beyond the illustrated environment 100. The network 258 may communicate, for example, Internet Protocol (IP) packets, Frame Relay frames, Asynchronous Transfer Mode (ATM) cells, voice, video, data, and other suitable information between network addresses. The network 258 may also include one or more local area networks (LANs), radio access networks (RANs), metropolitan area networks (MANs), wide area networks (WANs), all or a portion of the internet and/or any other communication system or systems at one or more locations.

The network 258 may incorporate a cloud platform/data center that support various service models including Platform as a Service (PaaS), Infrastructure-as-a-Service (IaaS), and Software-as-a-Service (SaaS). Such service models may provide, for example, a digital platform accessible to the user device (referring to either or both of the computing device 104 and the mobile device 106). Specifically, SaaS may provide a user with the capability to use applications running on a cloud infrastructure, where the applications are accessible via a thin client interface such as a web browser and the user is not permitted to manage or control the underlying cloud infrastructure (i.e., network, servers, operating systems, storage, or specific application capabilities that are not user-specific). PaaS also do not permit the user to manage or control the underlying cloud infrastructure, but this service may enable a user to deploy user-created or acquired applications onto the cloud infrastructure using programming languages and tools provided by the provider of the application. In contrast, IaaS provides a user the permission to provision processing, storage, networks, and other computing resources as well as run arbitrary software (e.g., operating systems and applications) thereby giving the user control over operating systems, storage, deployed applications, and potentially select networking components (e.g., host firewalls).

The network 258 may also incorporate various cloud-based deployment models including private cloud (i.e., an organization-based cloud managed by either the organization or third parties and hosted on-premises or off premises), public cloud (i.e., cloud-based infrastructure available to the general public that is owned by an organization that sells cloud services), community cloud (i.e., cloud-based infrastructure shared by several organizations and manages by the organizations or third parties and hosted on-premises or off premises), and/or hybrid cloud (i.e., composed of two or more clouds e.g., private community, and/or public).

Two external systems 202 and 204 are expressly illustrated in FIG. 1, representing any number and variety of data sources, users, consumers, customers, business entities, banking systems, government entities, clubs, and groups of any size are all within the scope of the descriptions. In at least one example, the external systems 202 and 204 represent automatic teller machines (ATMs) utilized by the enterprise system 200 in serving users 110. In another example, the external systems 202 and 204 represent payment clearinghouse or payment rail systems for processing payment transactions, and in another example, the external systems 202 and 204 represent third and fourth party systems such as merchant systems configured to interact with the user device 106 during transactions and also configured to interact with the enterprise system 200 in back-end transactions clearing processes.

In certain embodiments, one or more of the systems and devices, such as the user device (referring to either or both of the computing device 104 and the mobile device 106), the enterprise system 200, and/or the external systems 202 and 204 are, include, or utilize virtual resources. In some cases, such virtual resources are considered cloud resources or virtual machines. The cloud computing configuration may provide an infrastructure that includes a network of interconnected nodes and provides stateless, low coupling, modularity, and semantic interoperability. Such interconnected nodes may incorporate a computer system that includes one or more processors, a memory, and a bus that couples various system components (e.g., the memory) to the processor. Such virtual resources may be available for shared use among multiple distinct resource consumers and in certain implementations, virtual resources do not necessarily correspond to one or more specific pieces of hardware, but rather to a collection of pieces of hardware operatively coupled within a cloud computing configuration so that the resources may be shared as needed.

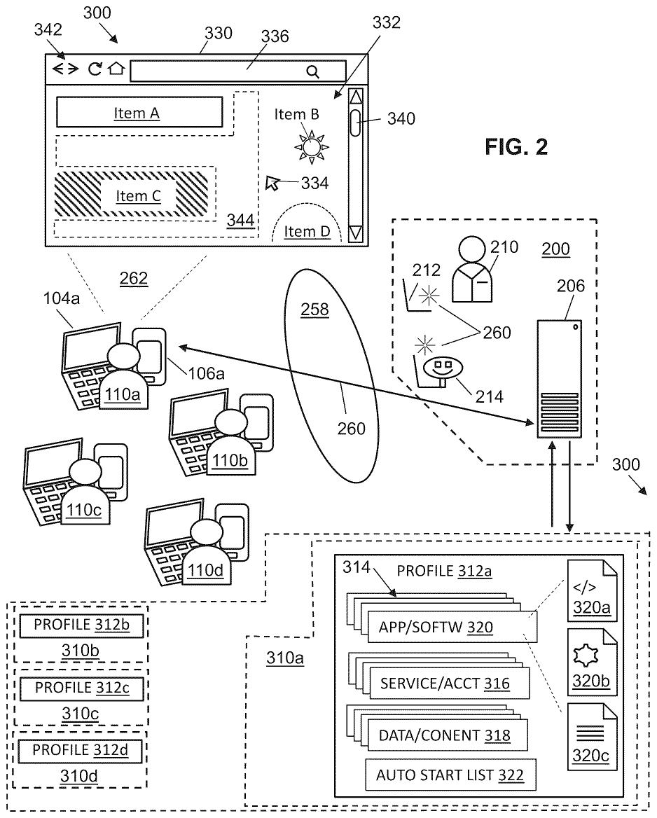

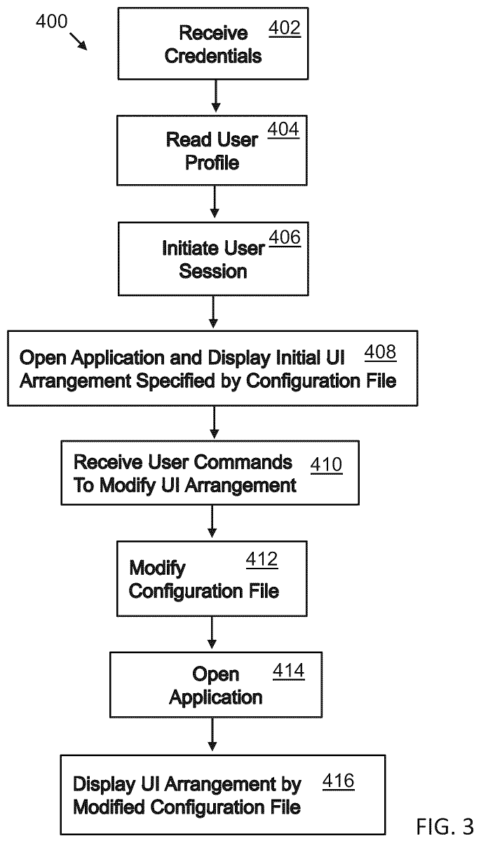

According to some embodiments of the above-described devices and systems, as further exemplified in FIG. 2, an advantageous system for securely customizing user interfaces in software controlled across multiple devices is provided and implements a corresponding method, as represented in flow-chart form in FIG. 3. The multiple illustrated user devices among the users (110a, 110b, 110c, 110d) shown in FIG. 2, of which devices 104a and 106a serve for brevity as singly described examples of others also illustrated, may be utilized by workers of a providing entity, customers a providing entity, clients of a providing entity, and/or workers of a business that is a client of a providing entity.

Briefly summarized, in some embodiments user interface (UI) configurations can be directly manipulated by end users of applications and programs to affect the appearance of elements displayed and utilized. The end user can move and configure tables, and resize windows, objects and items. End users can drag and drop content in a navigator, and set properties on forms, such as what type of navigation (horizontal or vertical) view the user prefers. Changes made on and in the interface done through direct manipulation are stored in the user's profile. In addition to users each having a respective personal profile, users can be assigned a default profile by an administrator. By direct end-user manipulation, many UI components can be configured including the below described or referenced non-limiting and non-exhaustive examples.

Window sizes and positions can be manipulated. A window manipulated in a user session retains its size and position when a subsequent user session occurs and the window is started again. Navigator contents can be manipulated. Items such as icons can be moved in a navigator. New items can be created for and/or within, for example, application forms, web pages, and external applications. Items can be hidden, and unhidden, and manipulated and affected in other ways. Table contents can be sized and positioned. For example, columns can be moved to change their order and resized. Columns can be locked as always visible without scrolling out of view. Table columns and fields can be hidden, and a user can control what fields are queried during a search of table contents.

Colors and background pictures can be manipulated by selection and/or adjustment. Colors used to highlight items can be manipulated, colors such as those indicating mandatory, changed, and read-only fields. Background pictures on a desktop or background in a window can be selected, replaced, and adjusted.

Form start-up behavior can be manipulated. A user can control, select, and revise whether a form should automatically perform a query, open a query dialog, create a new record, or just start empty when initiated. Form field sizes and positions can be user manipulated. User manipulation can cause a form field to switch with another. User manipulation can specify the entry sequence of form fields. User manipulation can specify additional and/or existing form fields as mandatory. User manipulation can specify additional and/or existing form fields as read only. User manipulation can adjust tabs and margins.

The system 200 is represented in abbreviated illustration in FIG. 2 for convenience to exemplify a system for securely customizing user interfaces in software controlled across multiple devices. The system 200 accordingly, with respect to such embodiments descriptions of which herein in instances refer to elements of the drawings by reference numbers without limiting those descriptions to depicted elements, includes or constitutes a computing system 206 of a first entity including one or more processor 220 configured to execute computer-readable instructions 226 (FIG. 1), at least one of a memory device and a non-transitory storage device (222, 224 FIG. 1), and a communication interface 250 for operatively connecting, via a communication network 258, the one or more processor to one or more user device.

Multiple users (110a, 110b, 110c, 110d) are illustrated in FIG. 2, representing examples each according to descriptions above with reference to the user 110 in FIG. 1. In the following, user actions, experiences, and user devices are once described with reference to the user 110a for brevity without express repetition with respect to users 110b, 110c, and 110d. These descriptions nonetheless refer to any number of users, their devices, the actions, and their experiences. The user 110a utilizes one or more user device, referring to either or both of the computing device 104a and the mobile device 106a.

The computing system 206 maintains and stores multiple data sets 310a, 310b, 310c, and 310d in association respectively with the users 110a, 110b, 110c, and 110d. Each user-specific data set 310a, 310b, 310c, and 310d includes a respective user-specific profile 312a, 312b, 312c, and 312d, for which the user-specific profile 312a associated with the user 110a serves as an example in these descriptions.

The representative profile 312a documents and/or stores records 314 representing applications, program, and software, records 316 representing services and accounts, and records 318 representing other data and digital content. Records 314 representing applications and software, as exemplified by the application 320 can include code and executable files 320a, configuration files 320b associated with the respective files 320a, and/or other files 320c also associated respectively with the files 320a.

The configuration files, represented by files 320b, in some embodiments, are files used to configure the parameters and initial settings, each for particular programs or applications represented by the code and/or executable files 320a. Such configuration files are typically termed config files. Programs and applications typically have their configuration files read at least at startup. In some cases, users and/or administrators can have some programs to again read the configuration files while running and apply changes to a current process.

The files 320c in some embodiments contain user-specific performance instructions for at least in part controlling behavior of specific programs represented by the code and/or executable files 320a. As with the configuration files 320b, programs and applications can have the files 320c read at startup and while running beyond startup. In some cases, users and/or administrators can have some programs to again read the files 320c while running and apply changes to a current process. In some cases the files 320c may serve similarly or the same as config files.

FIG. 2 illustrates the computing system 200, according to at least one embodiment, engaged in a user session in which the user 110a affects display arrangement modifications. FIG. 3 represents a method implemented thereby in flow-chart form as a non-limiting number of representative and non-exhaustive steps corresponding at least to functions in FIG. 2.

For each user device of the multiple user devices among the users (110a, 110b, 110c, 110d), and as represented by step 402 of the method 400 (FIG. 3), the computing system 206 (FIG. 2) can receive, via the network 258, login credentials from a specific user device of the multiple user devices, as represented by communications 260 representing signals and other content sent and received by a user device (104a, 106a) and signals and other content sent and received by the computing system 206.

Upon receipt of the login credentials, as represented by step 404 of the method 400 (FIG. 3), the system 206 (FIG. 2) reads a user-specific profile 312a associated with the received login credentials and the specific user 110a. The user-specific profile 312a contains an application list 314 identifying one or more particular application available to the specific user.

Upon confirmation of the login credentials, as represented by step 406 of the method 400 (FIG. 3), the computing system initiates and conducts a current user session 262 via the specific user device (104a, 106a), in which a user-navigation event is conducted. In the current user session 262, the computing system, for example in cooperation with the specific user device, opens the particular application 320 by execution of the corresponding code 320a and thereby causes, via the network connection, displaying by the specific user device items in a display arrangement in a user interface 330, the display arrangement specified at least in part in a configuration file 320b in the user-specific profile 310a, as represented by step 408 of the method 400 (FIG. 3).

The illustrated display arrangement 332, provided as a non-limiting example, is shown as the layout of contents of an application page or navigation window 300. User commands such as inputs are enabled for example via various input devices of the user device (104a, 106a) as described above with reference to FIG. 1. In FIG. 2, user input and/or commands can be made in part by control of a cursor 334, which may be controlled by the user via mouse, a finger touch position, and a stylus position in various examples. Content items referenced in FIG. 2 as Content Item A, Content Item B, Content Item C, and Content Item D are each available for selection, use, and manipulation by the user 110a. The display arrangement further refers to appearances and locations of icons and navigation tools such as an address bar 336, and a scroll tool 340, which are also content items available for selection, use, and manipulation. The navigation tools 342 (back, forward, reload, home) near the address bar are available for selection, use, and manipulation. The use of these by the user 110a represents user commands in accessing content, and thus by tracking user interactions with such content items, user preferences and use patterns may be determined. The efficacy and efficiency of user tasks during any given user session may be optimized by user-preferred items and their arrangement.

Accordingly, the computing system 206 may receive user commands, as represented by step 410 of the method 400 (FIG. 3), from the specific user device (104a, 106a) including instructions to modify the display arrangement 332, in response to which the computing system 206, for example in cooperation with the user device, modifies the configuration file according at least to the instructions to modify the display arrangement, as represented by step 412 of the method 400 (FIG. 3).

In order to a capture preferred modified display arrangement for later use, for example as a default arrangement in a subsequent user session or opening the particular application 320 of which the user interface 330 is a result or production, the computing system 206 stores the modified configuration file, referenced as configuration file 320b, in the user specific profile 312a.

Upon a subsequent opening of the particular application 320 for the specific user 110a, as represented by step 414 of the method 400 (FIG. 3), the computing system 206, for example in cooperation with the user device (104a, 106a), causes displaying, by the specific user device (104a, 106a), or other device used by the specific user 110a upon the subsequent opening, items in a display arrangement specified in the modified configuration file, as represented by step 416 of the method 400 (FIG. 3).

The display arrangement in the subsequent opening is modified relative to the prior arrangement according to the received user commands that included instructions to modify the display arrangement. The subsequent opening of the particular application 320 may be an automatic opening upon initiating a subsequent user session, such as occurs if the particular application is included in the start-up list 322, which is described in the following. The subsequent opening of the particular application 320 may be a user-requested or user-prompted opening as well, with or without, for example, terminating the current user session and initiating another.

The subsequent opening of the particular application 320 for the specific user 110a provides the display arrangement as previously modified by the user. Advantageously, efficiencies are gained, for example by workers using familiar and preferred interface arrangements as those arrangements are automatically regained upon opening user interfaces having previously modified arrangements without the need for users to repeat their organizational actions in rearranging display arrangements.

The instructions to modify the display arrangement may include any and all of instructions to resize a window, instructions to reposition a window, instructions to select a background image 344 in a window, and instructions to adjust a background image in a window. Background image 344 is broadly intended to represent user-preferred or preset pictures, colors, and or patterns.

The instructions to modify the display arrangement may include any and all of instructions to set a property on a form, instructions to set or revise whether a form should automatically prepopulate one or more field, instructions to set or revise whether a form should automatically perform a query, instructions to set or revise whether a form should open a query dialog, instructions to set or revise whether a form should create a new record, and instructions to set or revise whether at least one field in a form should start empty when initiated.

In the illustrated example, the user-specific profile comprises a start-up list 322 that includes an identification of each of one or more application for automatic opening upon initiating a user session. When reading the user-specific profile associated with the received login credentials, the computing system 206 reads each identification in the start-up list, and accordingly automatically opens each identified application upon opening a user session. The start-up list need not be implemented as a separate single consolidated file. Whether an application is to start automatically may be indicated in other stored files or contents, including, for example, configuration files 320b, other files 320c, and other profile contents, thus defining a start-up list whether that is defined as data in a single file or as data distributed and indexed elsewhere. The application list can be similarly defined and/or implemented.

Among changes a user can make according to their preferences, users in some embodiments are permitted the authority and functionality to choose what applications are identified in their start-up list, insofar as such a preferred application is available to the user. The computing system 206 may receive a user command, from the specific user device (104a, 106a) of any given session, to include or add an identification of a specific application in the start-up list. The computing system 206 then automatically determines whether the specific application is identified in the application list 314 in the user-specific profile. Upon determining the specific application is identified in the application list 314 in the user-specific profile 312a, the computing system 206 adds the identification of the specific application to the start-up list 322. Upon initiation of a subsequent user session, the added specific application is automatically accordingly opened.

The above-described systems and methods are distinguished over what can be feasibly accomplished by, for examples, manual action by system administrators assisting users in re-establishing preferred user-session settings and application display arrangements. As any given user session is initiated and conducted, the computing system concurrently conducts multiple other user sessions via other respective user devices. In modern computing environments, which effectively include distributed work forces and customer bases, only modern processors can feasibly handle the data flow of the above-described activities when dozens of user sessions, hundreds of user sessions, thousands of user sessions, and even tens of thousands of user sessions and beyond are conducted concurrently.

By relieving users from repeating their actions in modifying display arrangements in user interfaces, the efficiency of communications 260 between users and content providers is improved, for example, by minimizing navigational steps to the respective content each user prefers or frequents and display arrangement steps in configuring user interfaces to suit respective user preferences. This conserves network resources, improves communication networks and systems efficiencies, reduces costs, and lowers energy consumption. Data traffic on network connections is reduced, improving network efficiencies, and reducing latencies and operating costs.

Particular embodiments and features have been described with reference to the drawings. It is to be understood that these descriptions are not limited to any single embodiment or any particular set of features, and that similar embodiments and features may arise or modifications and additions may be made without departing from the scope of these descriptions and the spirit of the appended claims.

What is claimed is:

1. A system for securely customizing user interfaces in software controlled across multiple devices, the system comprising:
a computing system comprising one or more processor and at least one of a memory device and a non-transitory storage device, wherein said one or more processor executes computer-readable instructions; and
a network connection for operatively connecting multiple user devices to the computing system,
wherein, upon execution of the computer-readable instructions, the computing system performs steps comprising, for each user device of the multiple user devices:
receiving, via the network connection, login credentials from a specific user device of the multiple user devices;
reading a user-specific profile associated with the received login credentials and a specific user, the user-specific profile containing at least an application list identifying at least one particular application available to the specific user;
initiating and conducting a current user session via the specific user device, the current user session comprising the computing system:
opening the particular application thereby causing via the network connection displaying by the specific user device, items in a display arrangement in a user interface, the display arrangement specified in a configuration file in the user-specific profile;
receiving user commands from the specific user device, the user commands comprising instructions to modify the display arrangement;
modifying the configuration file according at least to the instructions to modify the display arrangement;
storing the modified configuration file in the user specific profile; and
upon a subsequent opening of the particular application for the specific user, causing displaying, by the specific user device or other device used by the specific user upon the subsequent opening, items in a display arrangement specified in the modified configuration file.

2. The system according to claim 1, wherein the instructions to modify the display arrangement comprise at least one of instructions to resize a window, instructions to reposition a window, instructions to select a background image in a window, and instructions to adjust a background image in a window.

3. The system according to claim 1, wherein the instructions to modify the display arrangement comprise at least one of instructions to set a property on a form, instructions to set or revise whether a form should automatically prepopulate one or more field, instructions to set or revise whether a form should automatically perform a query, instructions to set or revise whether a form should open a query dialog, instructions to set or revise whether a form should create a new record, and instructions to set or revise whether at least one field in a form should start empty when initiated.

4. The system of claim 1, wherein the user-specific profile comprises a start-up list comprising an identification of each of one or more application for automatic opening upon initiating a user session.

5. The system of claim 4, wherein reading the user-specific profile associated with the received login credentials comprises reading each identification in the start-up list.

6. The system of claim 5, wherein opening the particular application comprises automatically opening the particular application upon:
reading the user-specific profile comprising reading an identification of the particular application in the start-up list; and
initiating the current user session.

7. The system of claim 4, wherein the computing system further:
receives a user command from the specific user device to include an identification of a specific application in the start-up list;
automatically determines whether the specific application is identified in the application list in the user-specific profile; and
upon determining the specific application is identified in the application list in the user-specific profile, adds the identification of the specific application in the start-up list.

8. The system of claim 1, wherein the computing system, upon initiating and conducting the current user session via the specific user device, concurrently conducts multiple other user sessions via other respective user devices.

9. A system for securely customizing user interfaces in software controlled across multiple devices, the system comprising:
a computing system comprising one or more processor and at least one of a memory device and a non-transitory storage device, wherein said at least one of a memory device and a non-transitory storage device comprise stored computer-readable instructions and multiple user-specific profiles, each user-specific profile comprising an application list identifying applications available to a respective specific user, and a start-up list identifying which of the available applications are to be automatically opened upon initiating a user session for the specific user, wherein said one or more processor executes the computer-readable instructions; and
a network connection for operatively connecting multiple user devices to the computing system,
wherein, upon said one or more processor executing the computer-readable instructions, the computing system performs steps comprising, for each user device of the multiple user devices:
receiving, via the network connection, login credentials from a particular user device of the multiple user devices;
reading a particular user-specific profile of the multiple user-specific profiles, the particular user-specific profile associated with the received login credentials and a particular user;
initiating and conducting a current user session for the particular user via the particular user device, the current user session comprising the computing system:
automatically opening each of the available applications identified in the start-up list in the particular user-specific profile, thereby causing via the network connection displaying by the particular user device, items in a display arrangement in a user interface, the display arrangement specified in a configuration file in the particular user-specific profile;
receiving user commands from the specific user device, the user commands comprising instructions to modify the display arrangement;
modifying the configuration file according at least to the instructions to modify the display arrangement;
storing the modified configuration file in the particular user specific profile; and
upon a subsequent opening of the particular application for the particular user, causing displaying, by the particular user device or other user device used by the particular user upon the subsequent opening, items in a display arrangement specified in the modified configuration file.

10. The system according to claim 9, wherein the instructions to modify the display arrangement comprise at least one of instructions to resize a window, instructions to reposition a window, instructions to select a background image in a window, and instructions to adjust a background image in a window.

11. The system according to claim 9, wherein the instructions to modify the display arrangement comprise at least one of instructions to set a property on a form, instructions to set or revise whether a form should automatically prepopulate one or more field, instructions to set or revise whether a form should automatically perform a query, instructions to set or revise whether a form should open a query dialog, instructions to set or revise whether a form should create a new record, and instructions to set or revise whether at least one field in a form should start empty when initiated.

12. The system of claim 9, further comprising:
receiving a user command from the particular user device to include an identification of a specific application in the start-up list in the particular user-specific profile;
automatically determining whether the specific application is identified as available in the application list;
upon determining the specific application is identified as available in the application list, adding the identification of the specific application in the start-up list.

13. The system of claim 12, further comprising initiating a subsequent user session for the particular user via the particular user device or other device used by the particular user upon initiating the subsequent user session, the subsequent user session comprising the computing system:
automatically opening each of the available applications identified in the start-up list in the particular user-specific profile including the specific application the identification which was added to the start-up list.

14. The system of claim 9, wherein the computing system, upon initiating and conducting the current user session for the particular user via the particular user device, concurrently conducts multiple other user sessions via other respective user devices.

15. A method for a computing system to securely customize user interfaces in software controlled across multiple devices, the computing system including one or more processor and at least one of a memory device and a non-transitory storage device storing computer-readable instructions, the one or more processor configured to execute the computer-readable instructions, and a network connection for operatively connecting multiple user devices to the computing system, the method comprising, upon execution of the computer-readable instructions, the computing system performing steps comprising, concurrently for each user device of the multiple user devices:
receiving, via the network connection, login credentials from a specific user device of the multiple user devices;
reading a user-specific profile associated with the received login credentials and a specific user, the user-specific profile containing at least an application list identifying at least one particular application available to the specific user;
initiating and conducting a current user session via the specific user device, the current user session comprising the computing system:
opening the particular application thereby causing via the network connection displaying by the specific user device, items in a display arrangement in a user interface, the display arrangement specified in a configuration file in the user-specific profile;
receiving user commands from the specific user device, the user commands comprising instructions to modify the display arrangement;
modifying the configuration file according at least to the instructions to modify the display arrangement;
storing the modified configuration file in the user specific profile; and
upon a subsequent opening of the particular application for the specific user, causing displaying, by the specific user device or other device used by the specific user upon the subsequent opening, items in a display arrangement specified in the modified configuration file.

16. The method according to claim 15, wherein the instructions to modify the display arrangement comprise at least one of instructions to resize a window, instructions to reposition a window, instructions to select a background image in a window, and instructions to adjust a background image in a window.

17. The method according to claim 15, wherein the instructions to modify the display arrangement comprise at least one of instructions to set a property on a form, instructions to set or revise whether a form should automatically prepopulate one or more field, instructions to set or revise whether a form should automatically perform a query, instructions to set or revise whether a form should open a query dialog, set or revise whether a form should create a new record, and set or revise whether at least one field in a form should start empty when initiated.

18. The method of claim 15, wherein the user-specific profile comprises a start-up list comprising an identification of each of one or more application for automatic opening upon initiating a user session.

19. The method of claim 18, wherein reading the user-specific profile associated with the received login credentials comprises reading each identification in the start-up list.

20. The system of claim 19, wherein opening the particular application comprises automatically opening the particular application upon:
reading the user-specific profile comprising reading an identification of the particular application in the start-up list; and
initiating the current user session,
wherein the method further comprises, upon receiving a user command from the specific user device to include an identification of a specific application in the start-up list:
automatically determining whether the specific application is identified in the application list in the user-specific profile; and
upon determining the specific application is identified in the application list in the user-specific profile, adding the identification of the specific application in the start-up list.
